(19) United States
(12) Patent Application Publication
(10) Pub. No.: US 2010/0279085 A1
(43) Pub. Date: Nov. 4, 2010

(54) Nonwoven Composite Including Post-Consumer Recycled Material

(76) Inventors: Gabriel Hammam Adam, Alpharetta, GA (US); Henry Skoog, Roswell, GA (US)

Correspondence Address: KIMBERLY-CLARK WORLDWIDE, INC.;Tara Pohlkotte, 2300 Winchester Rd., NEENAH, WI, 54956, US

(21) Appl. No.: 12/770,812

(22) Filed: Apr. 30, 2010

Related U.S. Application Data
(60) Provisional application No. 61/214,999, filed on Apr. 30, 2009.

(51) Int. Cl. B32B 7/04; B32B 5/26; B32B 5/02

(52) U.S. Cl. 428/196; 442/408; 428/219; 442/401

(57) ABSTRACT

The present invention provides for a nonwoven web composite which contains at least 40% by weight of post consumer recycled materials. It has been surprisingly discovered that a nonwoven web composite of the present invention, with its fairly high post consumer recycled material content, has physical properties similar to those of a nonwoven web composite prepared from virgin materials.

### CROSS-REFERENCE TO RELATED APPLICATION

This application claims the benefit of U.S. Provisional Patent Application Ser. No. 61/214,999 filed Apr. 30, 2009, the entirety of which is incorporated by reference herein.

### FIELD OF THE INVENTION

The present invention generally relates to a composite nonwoven web structure containing an amount of post-consumer recycled material.

### BACKGROUND OF THE INVENTION

Hydroentangled nonwoven composites having fibers hydraulically entangled with a continuous fiber web are known in the art, and are taught in various patents and publications including, for example, U.S. Pat. No. 4,808,467 to Suskind and U.S. Pat. No. 5,284,703 to Everhart et al. Hydroentangled nonwoven composites made from absorbent fibers which are entangled with the continuous fiber web are known in the art for being durable, having abrasion resistance while still being absorbent. Typically, these composites were made with virgin fibers.

In recent years, there has been increased interest in using recycled materials or fibers in disposable products, such as wipers. Generally, the thought is that using recycled materials are better for the environment and that the use of natural resources for disposable products leads to a waste of natural resources. In addition, increasing expenses associated with obtaining raw materials and constantly increasing consumption of various products provide a strong economic incentive for developing methods for recycling surplus or unused material, which would otherwise go to waste by being burned or placed in a landfill. However, the use of recycled materials and fibers has drawbacks. It is generally recognized in the art that recycled materials and fibers often result in products that have physical properties which are generally less acceptable than products made from virgin materials or fibers. As a result, the amount of recycled materials or fibers used in products is often limited due to the lost in physical properties of products prepared from recycled fibers.

Hydroentangled nonwoven composites have been used in a variety of applications, including wiping products such as wipers. In the field of wipers, it is important that the wiper be durable, and capable of absorbing and holding liquids. However, past attempts to use recycled materials and fibers in wiping products have yield wiping products which have inferior properties as compared to those wiping products prepared from virgin materials. As a result there is a need in the art for wiping products which are at least partially prepared from recycled materials which have properties at least comparable to those wiping products made with virgin materials.

### SUMMARY OF THE INVENTION

Generally stated, the present invention provides for a nonwoven web composite which contains at least 40% by weight of post consumer recycled materials. Surprisingly, it has been discovered that a nonwoven web composite of the present invention, with its fairly high post consumer recycled content has physical properties similar to those of a nonwoven web composite prepared from virgin materials. This result was result was unexpected since typically replacing virgin fibers with recycled fibers often lead to a product having diminished physical properties, as will be shown in the examples of contained within this disclosure.

In an embodiment of the present invention, the nonwoven composite web of the present invention is prepared from a nonwoven continuous fiber nonwoven web, and a layer of discontinuous fibers which are hydroentangled with the nonwoven continuous fiber web to form a nonwoven composite. At least 40% by weight of the composite is a post-consumer recycled material. Either the continuous fiber nonwoven web, the discontinuous fibers or both may contain the post consumer recycled material.

In another embodiment of the present invention, between about 40% and about 80% by weight of the nonwoven composite is prepared from the post-consumer recycled material. In a further embodiment, the nonwoven composite contains about 45% to about 65% by weight of the nonwoven composite contains post-consumer recycled material. The nonwoven composite can contain up to 100% by weight of the post consumer recycled material.

In one embodiment of the present invention, the nonwoven composite has a basis weight between about 20 g/m² and 200 g/m².

In a further embodiment of the present invention, the continuous fiber web may be bonded prior to hydroentangling with the discontinuous fibers. Generally, the continuous fiber web has a bond density greater than about 250 point bonds per square inch and the total bond area is less than about 30 percent.

In a further embodiment of the present invention, the post consumer recycled materials are pulp fibers, derived from paper sources. The post consumer recycled material may also be polyethylene terephthalate from recycled plastic sources. The continuous fiber nonwoven web may be prepared from recycled plastic and synthetic staple fibers may be prepared from recycled plastic.

In another embodiment of the present invention, the nonwoven composite may be used as a wiper, which is used for wiping or absorbing fluids form surfaces.

### BRIEF DESCRIPTION OF THE DRAWINGS

FIG. 1 shows an exemplary process for preparing the nonwoven composite of the present invention.

FIG. 2 shows a plan view of an exemplary bond pattern useable in the present invention.

FIG. 3 shows a plan view of an exemplary bond pattern useable in the present invention.

FIG. 4 shows a plan view of an exemplary bond pattern useable in the present invention.

### DEFINITIONS

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

The term “post-consumer recycled material” as used herein generally refers to material that can originate from post-consumer sources such as domestic, distribution, retail, industrial, and demolition. “Post-consumer fibers” means fibers obtained from consumer products that have been discarded for disposal or recovery after having completed their intended uses and is intended to be a subset of post consumer recycled materials. Post-consumer materials may be obtained from the sorting of materials from a consumer or manufacturer waste stream prior to disposal. This definition is intended to include materials which are used to transport product to a consumer, including, for example, corrugated cardboard containers.

The term “machine direction” as used herein refers to the direction of travel of the forming surface onto which fibers are deposited during formation of a nonwoven web.

The term “cross-machine direction” as used herein refers to the direction which is perpendicular to the machine direction defined above.

The term “fiber” or “fibers” as used herein refers to discontinuous (e.g. pulp or staple) fibers, or continuous (e.g. spunbond filament) fibers. These fibers may be prepared from virgin materials, post-consumer recycled materials, or mixtures thereof.

The term “staple fibers” as used herein refers to either natural fibers or synthetic fibers having a cut length from filaments produced from conventional, fiber spinning and drawing processes.

The term “pulp” as used herein refers to fibers from natural sources such as woody and non-woody plants. Woody plants include, for example, deciduous and coniferous trees. Non-woody plants include, for example, cotton, flax, esparto grass, milkweed, straw, jute hemp, bamboo, and bagasse.

The term “weight weighted average fiber length” as used herein refers to a weighted average length of fibers determined by utilizing a HiRes Fiber Quality Analyzer (FQA) available from OpTest Equipment Inc., 900 Tupper St. Hawkesbury, ON Canada K6A 3S3 P. The FQA meets or exceeds the specification of Tappi Test Method T271, PAPTAC B.4 and ISO 16065. According to the test procedure, a fiber sample is treated with a macerating liquid to ensure that no fiber bundles or shives are present. Each fiber sample is disintegrated into water and diluted to an approximately 0.001% solution. Individual test samples are drawn in approximately 50 to 100 ml portions from the dilute solution when tested using the standard OpTest fiber analysis test procedure. The weight weighted average fiber length may be expressed by the following equation:

Weight Weighted Average Fiber Length may be expressed by the following equation:

$${\sum }_{{L}_{i} = 0}^{k} ( {L}_{i} * {N}_{i} ) / N$$

where

k=maximum fiber length

Lᵢ=fiber length

Nᵢ=number of fibers having length Lᵢ

n=total number of fibers measured.

The term “low average weight weighted average fiber length” as used herein refers to fibers that contain a significant amount of short fibers and non-fiber particles. Many secondary wood fibers may be considered low average fiber length; however, the quality of the secondary wood fibers will depend on the quality of the recycled fibers and the type and amount of previous processing. Low average weight weighted average fiber length fibers may have a weight weighted average fiber length of less than about 1.1 mm as determined by a fiber quality analyzer. For example, weight weighted low-average weight weighted average fiber length fibers may have an average weight weighted fiber length ranging from about 0.7 to 1.1 mm. Exemplary low-average weight weighted average fiber length fibers include virgin hardwood pulp, and secondary fiber pulp from sources such as, by way of example only, office waste, newsprint, and paperboard scrap.

The term “high average weight weighted average fiber length” as used herein refers to fibers that contain a relatively small amount of short fibers and non-fiber particles. High average weight weighted average fiber length fibers are typically formed from certain non-secondary (i.e., virgin) fibers. Secondary wood fibers which have been screened or washed may also have a high-average weight weighted fiber length. High average weight weighted average fiber length fibers typically have an average weight weighted fiber length of greater than about 1.5 mm as determined by a fiber quality analyzer mentioned above. For example, a high-average weight weighted average fiber length fibers may have an average fiber length froth about 1.5 mm to about 6 mm. Exemplary high average weight weighted average fiber length fibers which are wood fiber pulps include, for example, bleached and unbleached virgin softwood fiber pulps.

The term “average weight weighted average fiber length” as used herein refers to fibers that contain a moderate amount of short fibers and non-fiber particles. Average weight weighted average fiber length fibers are typically formed from blends of non-secondary (i.e., virgin) fibers and secondary wood fibers. Average weight weighted average fiber length fibers typically have an average weight weighted fiber length between about 1.1 mm to about 1.5 mm as determined by the fiber quality analyzer mentioned above. Exemplary average weight weighted average fiber length fibers include wood fiber pulps, for example, blends of bleached and unbleached virgin softwood and/or hardwood fiber pulps, or blends of secondary and/or virgin pulp fibers.

As used herein the term “spunbond fibers” refers to small diameter fibers of molecularly oriented polymeric material. Spunbond fibers may be formed by extruding molten thermoplastic material as fibers from a plurality of fine, usually circular capillaries of a spinneret with the diameter of the extruded fibers then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making up the fibers. The polymers are usually different from each other, although conjugate fibers may be prepared from the same polymer, if the polymer in each component is different from one another in some physical property, such as, for example, melting point, glass transition temperature or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Fibers of this general type are discussed in, for example, U.S. Pat. Nos. 5,108,827 and 5,294,482 to Gessner.

### DETAILED DESCRIPTION OF THE INVENTION

The present invention provides for a nonwoven web composite which contains at least 40% by weight of post consumer recycled materials. It has been surprisingly discovered that a nonwoven web composite of the present invention, with its fairly high post consumer recycled material content, has physical properties similar to those of a nonwoven web composite prepared from virgin materials. This result was unexpected given the general trend in the art that shows the recycled materials yields end products with inferior physical properties.

In one embodiment of the present invention, the nonwoven composite web of the present invention is prepared from a continuous fiber nonwoven web, and a layer of discontinuous fibers which are hydroentangled with the nonwoven continuous fiber web to form a nonwoven composite. At least 40% by weight of the composite is a post-consumer recycled material. Either the continuous fiber nonwoven web, the discontinuous fibers or both may contain the post consumer recycled material.

The continuous fiber nonwoven web is generally prepared with continuous fibers that are prepared from thermoplastic materials. As a result, the continuous fiber nonwoven web may be a continuous thermoplastic fiber nonwoven web. The thermoplastic fibers of the continuous fiber nonwoven web may be formed by known nonwoven extrusion processes, such as, for example, known solvent spinning or melt-spinning processes, for example, spunbonding or meltblowing. It is noted that in the present invention, the continuous thermoplastic fibers of the continuous fiber nonwoven web may be prepared from virgin thermoplastic materials, post consumer recycled materials or a mixture of both virgin thermoplastic materials and post consumer recycled materials.

The thermoplastic fibers may be formed from any solvent-spinnable or melt-spinnable thermoplastic polymer, co-polymers or blends thereof. Suitable polymers for the present invention include, but are not limited to, polyolefins, polyamides, polyesters, polyurethanes, blends and copolymers thereof, and so forth. Desirably, the thermoplastic fibers comprise polyolefins, and even more desirably the thermoplastic fibers comprise polypropylene and polyethylene. Suitable fiber forming polymer compositions may additionally have thermoplastic elastomers blended therein. Optionally, the thermoplastic fibers may be multicomponent fibers consisting of two or more different polymers. The thermoplastic fibers may be round or any the suitable shape known to those skilled in the art, including but not limited to, bilobal, trilobal, and so forth. Desirably, the thermoplastic fibers within a layer have a basis weight from about 8 to about 70 gsm. More desirably, the thermoplastic fibers have a basis weight from about 10 to about 35 gsm. Other components or additives may be added to the thermoplastic material used to prepare the thermoplastic fibers including, for example, pigments, antioxidants, flow promoters, stabilizers, fragrances, abrasive particles, filler and the like.

The discontinuous fibers which are hydroentangled with the nonwoven continuous fiber web may be synthetic staple fibers which are non-thermoplastic fibers, thermoplastic fibers or blends thereof. The discontinuous fibers may be formed into a web and entangled with the continuous fibers or the discontinuous fibers may be laid upon the continuous web and entangled with the continuous web. Generally, the discontinuous fibers are staple fibers. Staple fibers often have a fiber length in the range of from about 1 to about 150 millimeters, in some embodiments from about 5 to about 50 millimeters, in some embodiments from about 10 to about 40 millimeters, and in some embodiments, from about 10 to about 25 millimeters. Generally, staple fibers are carded using a conventional carding process, e.g., a woolen or cotton carding process. Other processes, however, such as air laid or wet laid processes, may also be used to form the staple fiber web. Examples of non-thermoplastic fiber include staple fibers pulp fibers, which are defined above. A wide variety of polymeric materials are known to be suitable for use in fabricating staple fibers. Examples include, but are not limited to, polyolefins, polyesters, polyamides, as well as other melt-spinnable and/or fiber forming polymers. Any convention polymers typically used to produce fibers may be used as the polymeric component to produce the staple fibers usable in the present invention. Other suitable staple fibers include, but are not limited to, acetate staple fibers, rayon staple fibers, Nomex® staple fibers, Kevlar® staple fibers, polyvinyl alcohol staple fibers, lyocell staple fibers, and so forth.

The staple fibers useable to produce the nonwoven composite may also be multicomponent (e.g., bicomponent) staple fibers. For example, suitable configurations for the multicomponent fibers include side-by-side configurations and sheath-core configurations, and suitable sheath-core configurations include eccentric sheath-core and concentric sheath-core configurations. In some embodiments, as is well known in the art, the polymers used to form the multicomponent fibers have sufficiently different melting points to form different crystallization and/or solidification properties. The multicomponent fibers may have from about 20% to about 80%, and in some embodiments, from about 40% to about 60% by weight of the low melting polymer. Further, the multicomponent fibers may have from about 80% to about 20%, and in some embodiments, from about 60% to about 40%, by weight of the high melting polymer. When bicomponent or multicomponent fibers are used as the staple fiber or are a portion of the staple fibers, the composite may be further bonded by using heat.

In a further aspect of the invention, the nonwoven web composite may also contain various materials such as, for example, activated charcoal, clays, starches, and superabsorbent materials. For example, these materials may be added to the non-thermoplastic absorbent staple fibers prior to their incorporation into the composite layer. Alternatively and/or additionally, these materials may be added to the composite after the non-thermoplastic absorbent staple fibers and thermoplastic fibers are combined. Useful superabsorbents are known to those skilled in the art of absorbent materials.

It may be desirable to use finishing steps and/or post treatment processes to impart selected properties to the nonwoven web composite. For example, the nonwoven web composite may be subjected to mechanical treatments, chemical treatments, and so forth. Mechanical treatments include, by way of non-limiting example, pressing, creping, brushing, and/or pressing with calender rolls, embossing rolls, and so forth to provide a uniform exterior appearance and/or certain tactile properties. Chemical post-treatments include, by way of non-limiting example, treatment with adhesives, dyes, and so forth.

In addition to, or in the alternative, in place of the continuous fibers and discontinuous fibers described above, the nonwoven composite of the present invention also contains at least 40% by weight of fibers prepared from post consumer recycle (PCR). Post consumer recycled material can be commercial transport packaging, including bottles and other containers, computer print-outs, magazines, direct mail materials, home office materials, boxes, old magazines from residential or office collections, old newspapers from residential or office collections, reclaimed household scrap paper and, packaging, reclaimed office waste paper, used corrugated boxes, used tabulating cards, and the like. These are fibrous post consumer recycle materials which are generally used as recycled fibers and will yield non-thermoplastic fibers, which can be used as the discontinuous fibers. For the most part, the post consumer recycled fibers form the paper sources will result in pulp based recycled fibers. Post consumer recycled materials may also include synthetic materials such as polymeric materials. Sources of synthetic post-consumer recycled materials include plastic bottles, e.g. soda bottles, plastic films, plastic packaging materials, plastic bags and other similar materials which contain synthetic materials which can be recovered. Generally, synthetic materials are reprocessed by melting the synthetic post-consumer recycled materials and reprocessing the melted synthetic post consumer recycled materials into fibers. Alternatively, the synthetic post consumer recycled materials may be processed into polymer pellets which can later be melted and formed into fibers. Specific examples, which are intended to be non-limiting, included polyester's derived from soft drink and water bottles and polypropylene derived from waste plastic sources. Synthetic post consumer recycled materials useable in the present invention may be used to prepare discontinuous fibers or continuous fibers.

In the present invention, the post consumer recycled (PCR) material content of the composite nonwoven web is at least 40% by weight based on the total weight of the composite nonwoven web. The post consumer recycled material may be as much as 100% by weight of the nonwoven composite. Generally, the nonwoven composite will contain between about 40% to about 80% by weight of post consumer recycled materials. More particularly, the nonwoven composite will contain between about 45% to about 65% by weight of post consumer recycled materials. The post consumer recycled materials may be contained only in the discontinuous fibers, only in the continuous fibers or may be contained in both discontinuous and continuous fibers. In the nonwoven composite of the present invention, the discontinuous fibers from post-consumer recycled sources include both natural fibers and synthetic fibers. The synthetic fibers may be recovered form products containing synthetic fibers or may be formed by reprocessing both fibrous and non-fibrous post-consumer recycled sources. The non-fibrous post-consumer recycled materials are typically melted and reprocessed into fibers.

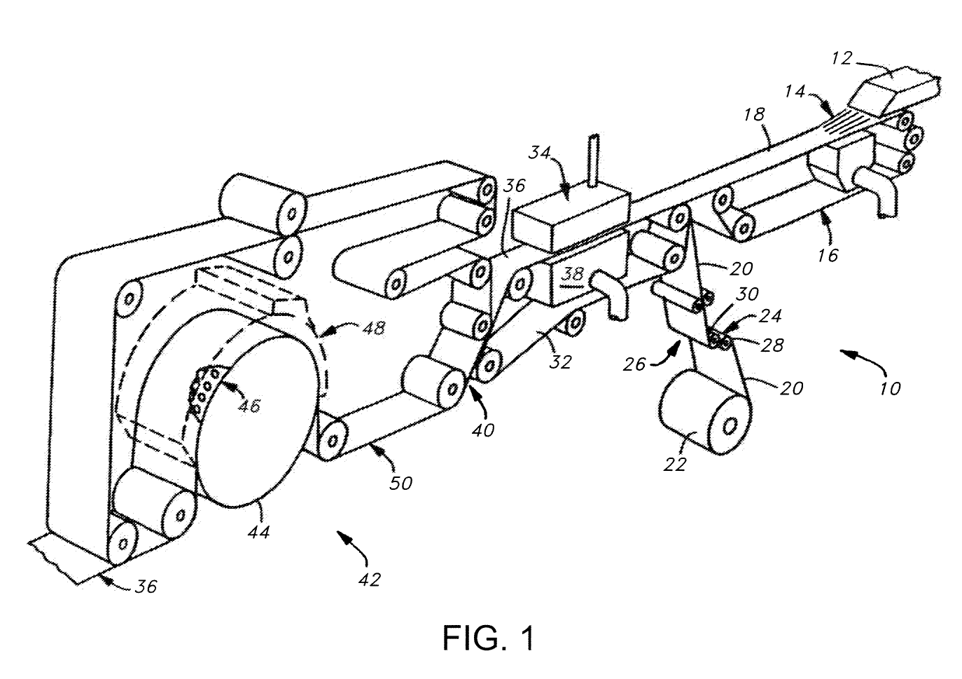

To gain a better understanding of the present invention, attention is directed to the Figures of the present specification. Referring to FIG. 1, there is schematically illustrated a process 10 for forming a nonwoven composite of the present invention. As is stated above, the nonwoven composite of the present invention may consist of all post-consumer recycled material, or only comprise post-consumer recycled material in part. For example, continuous fibers and/or discontinuous fibers may consist of all post-consumer recycled material, or comprise only in part post-consumer recycled material. Further, the present invention contemplates the post-consumer recycled material can be any form or shape.

According to the present invention, a dilute suspension of discontinuous fibers is supplied by a head-box 12 and deposited via a sluice 14 in a uniform dispersion onto a forming fabric 16 of a conventional papermaking machine. The suspension of fibers may be diluted to any desired consistency. For example, the suspension may contain from about 0.01 to about 1.5 percent by weight fibers suspended in water. Water is removed from the suspension of fibers to form a layer of discontinuous fibers 18.

Small amounts of wet-strength resins and/or resin binders may be added to improve strength and abrasion resistance. Useful binders and wet-strength resins include, for example, Kymene 557H available from the Ashland Hercules Chemical Company. Cross-linking agents and/or hydrating agents may also be added to the fiber mixture. Debonding agents may be added to the fiber mixture to reduce the degree of any potential hydrogen bonding if a very open or loose nonwoven fiber web is desired. One exemplary debonding agent is available from the Quaker Chemical Company, Conshohocken, Pa., under the trade designation Quaker 2008. The addition of certain debonding agents in the amount of, for example, 0.1 to 4 percent, by weight, of the composite also appears to reduce the measured static and dynamic coefficients of friction and improve the abrasion resistance of the continuous filament rich side of the nonwoven composite. The de-bonder is believed to act as a lubricant or friction reducer.

A continuous filament, i.e., fiber, nonwoven web 20 is unwound from a supply roll 22, and passes through a nip 24 of an S-roll arrangement 26 formed by the stack rollers 28 and 30. The nonwoven web 20 may be formed by known continuous filament nonwoven extrusion processes, such as, for example, known solvent spinning or melt-spinning processes, and passed directly through the nip 24 without first being stored on a supply roll. The continuous filament nonwoven web 20 can be a nonwoven web of continuous melt-spun filaments formed by the spunbond process. The melt-spun filaments may be formed from any melt-spinnable polymer, co-polymers or blends thereof which are described above. In addition, the web 20 may consist of all post-consumer recycled material, or only comprise in part post-consumer recycled material.

If the filaments are formed from a polyolefin such as, for example, polypropylene, the nonwoven substrate 20 may have a basis weight from about 3.5 to about 70 grams per square meter (gsm). More particularly, the nonwoven substrate 20 may have a basis weight from about 10 to about 35 gsm. The polymers may include additional materials such as, for example, pigments, antioxidants, flow promoters, stabilizers and the like.

One important characteristic of the nonwoven continuous filament web 20 is that it has a total bond area of less than about 30 percent and a uniform bond density greater than about 100 bonds per square inch. For example, the nonwoven continuous filament web may have a total bond area from about 2 to about 30 percent (as determined by conventional optical microscopic methods) and a bond density from about 250 to about 600 pin bonds per square inch.

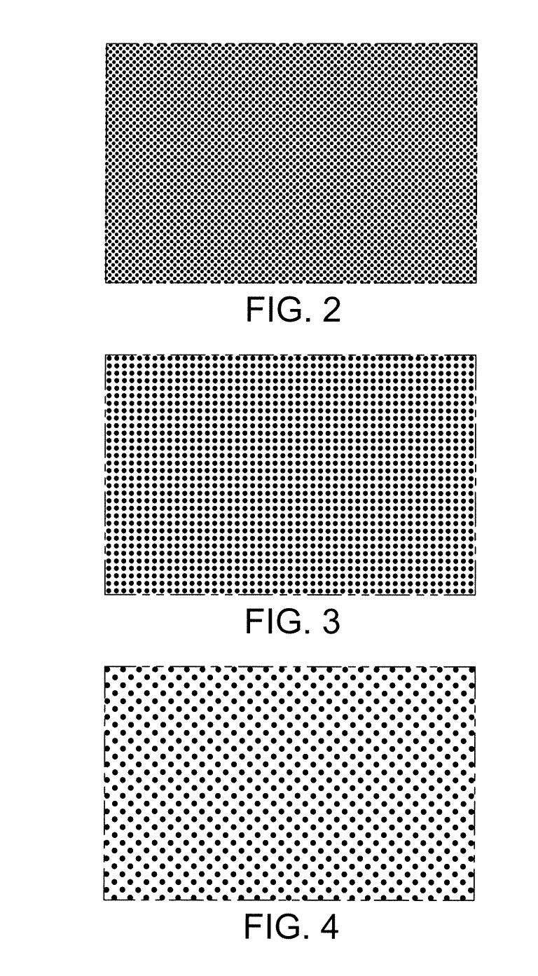

Such a combination total bond area and bond density may be achieved by bonding the continuous filament web with a pin bond pattern having more than about 100 pin bonds per square inch which provides a total bond surface area less than about 30 percent when fully contacting a smooth anvil roll. The upper limit of bonds per square inch could be 600 pin bonds, or more, per square inch. As the number of pin bonds per square inch increases, the size of the pins will generally decrease in order to maintain the bond density within a desired range. Desirably, the bond pattern may have a pin bond density from about 250 to about 350 pin bonds per square inch and a total bond surface area from about 10 percent to about 25 percent when contacting a smooth anvil roll. An exemplary bond pattern is shown in FIG. 2. That bond pattern has a pin density of about 306 pins per square inch. Each pin defines square bond surface having sides which are about 0.025 inch in length. When the pins contact a smooth anvil roller they create a total bond surface area of about 15.7 percent. High basis weight webs generally have a bond area which approaches that value. Lower basis weight webs generally have a lower bond area. FIG. 3 is another exemplary bond pattern. The pattern of FIG. 3 has a pin density of about 278 pins per square inch. Each pin defines a bond surface having 2 parallel sides about 0.035 inch long (and about 0.02 inch apart) and two opposed convex sides—each having a radius of about 0.0075 inch. When the pins contact a smooth anvil roller they create a total bond surface area of about 17.2 percent. FIG. 4 is another bond pattern which may be used. The patter of FIG. 4 has a pin density of about 103 pins per square inch. Each pin defines a square bond surface having sides which are about 0.043 inch in length. When the pins contact a smooth anvil roller they create a total bond surface area of about 16.5 percent.

Although pin bonding produced by thermal bond rolls is described above, the present invention contemplates any form of bonding which produces good tie down of the filaments with minimum overall bond area, such as a hot air knife (HAK). Another example is a combination of thermal bonding and latex impregnation may be used to provide desirable filament tie down with minimum bond area. Alternatively and/or additionally, a resin, latex or adhesive may be applied to the nonwoven continuous filament web by, for example, spraying or printing, and dried to provide the desired bonding.

The layer of fibers 18 are then laid on the nonwoven web 20 which rests upon a foraminous entangling surface 32 of a conventional hydraulic entangling machine. It is preferable that the fibers 18 are between the nonwoven web 20 and the hydraulic entangling manifolds 34. The layer of fibers 18 and nonwoven web 20 pass under one or more hydraulic entangling manifolds 34 and are treated with jets of fluid to entangle all, or at least a major portion, of the fibers with the filaments of the continuous filament nonwoven web 20. The jets of fluid also drive fibers into and through the nonwoven web 20 to form the composite 36.

Alternatively, hydraulic entangling may take place while the layer of fibers 18 and nonwoven web 20 are on the same foraminous screen (i.e., mesh nonwoven composite) on which the wet-laying took place. The present invention also contemplates superposing a dried sheet on a continuous filament nonwoven web, rehydrating the dried sheet to a specified consistency and then subjecting the rehydrated sheet to hydraulic entangling.

The hydraulic entangling may take place while the fibers 18 are highly saturated with water. For example, the layer of fibers 18 may contain up to about 90 percent by weight water just before hydraulic entangling. Alternatively, the fibers may be an air-laid or dry-laid layer of fibers.

The hydraulic entangling may be accomplished utilizing conventional hydraulic entangling equipment such as may be found in, for example, in U.S. Pat. No. 3,485,706 to Evans, the disclosure of which is hereby incorporated by reference. The hydraulic entangling of the present invention may be carried out with any appropriate working fluid such as, for example, water. The working fluid flows through a manifold which evenly distributes the fluid to a series of individual holes or orifices. These holes or orifices may be from about 0.003 to about 0.015 inch in diameter. For example, the invention may be practiced utilizing a manifold produced by Rieter-PerfoJet, Inc. of Grenoble, France. Many other manifold configurations and combinations may be used. For example, a single manifold may be used or several manifolds may be arranged in succession.

In the hydraulic entangling process, the working fluid passes through the orifices at a pressures ranging from about 200 to about 3000 pounds per square inch gage (psig). At the upper ranges of the described pressures it is contemplated that the nonwoven composites may be processed at speeds of about 1500 feet per minute (fpm). The fluid impacts the fibers 18 and the nonwoven web 20 which are supported by a foraminous surface which may be, for example, a single plane mesh having a mesh size of from about 8×8 to about 100×100. The foraminous surface may also be a multi-ply mesh having a mesh size from about 50×50 to about 200×200. As is typical in many water jet treatment processes, vacuum slots 38 may be located directly beneath the hydro-needling manifolds or beneath the foraminous entangling surface 32 downstream of the entangling manifold so that excess water is withdrawn from the hydraulically entangled composite 36.

Although the inventors should not be held to a particular theory of operation, it is believed that the columnar jets of working fluid which directly impact fibers laying on the nonwoven continuous filament web work to drive those fibers into and partially through the matrix or nonwoven network of filaments in the web. When the fluid jets and fibers interact with a nonwoven continuous filament web having the above-described bond characteristics (and a filament diameter in the range of from about 5 microns to about 40 microns) the fibers are also entangled with filaments of the nonwoven web and with each other. On the other hand, if the total bond area of the web is too great, the fiber penetration may be poor. Moreover, too much bond area will also cause a splotchy nonwoven composite because the jets of fluid will splatter, splash and wash off fibers when they hit the large non-porous bond spots. The specified levels of bonding provide a coherent web which may be formed into a nonwoven composite by hydraulic entangling on only one side and still provide a strong, useful nonwoven composite as well as a nonwoven composite having desirable dimensional stability.

In one aspect of the invention, the energy of the fluid jets that impact the fibers and web may be adjusted so that the fibers are inserted into and entangled with the continuous filament web in a manner that enhances the two-sidedness of the nonwoven composite. That is, the entangling may be adjusted to produce high fiber concentration on one side of the nonwoven composite and a corresponding low fiber concentration on the opposite side. Alternatively, the continuous filament web may be entangled with a fiber layer on one side and a different fiber layer on the other side.

After the fluid jet treatment, the nonwoven composite 36 may be transferred to a non-compressive drying operation. A differential speed pickup roll 40 may be used to transfer the material from the hydraulic needling belt to a non-compressive drying operation. Alternatively, conventional vacuum-type pickups and transfer nonwoven composites may be used. If desired, the nonwoven composite may be wet-creped before being transferred to the drying operation. Non-compressive drying of the web may be accomplished utilizing a conventional rotary drum through-air drying apparatus shown in FIG. 1 at 42. The through-dryer 42 may be an outer rotatable cylinder 44 with perforations 46 in combination with an outer hood 48 for receiving hot air blown through the perforations 46. A through-dryer belt 50 carries the nonwoven composite 36 over the upper portion of the through-dryer outer cylinder 40. The heated air forced through the perforations 46 in the outer cylinder 44 of the through-dryer 42 removes water from the nonwoven composite 36. The temperature of the air forced through the nonwoven composite 36 by the through-dryer 42 may range from about 200° to about 500° F. Other useful through-drying methods and apparatus may be found in, for example, U.S. Pat. Nos. 2,666,369 and 3,821,068, the contents of which are incorporated herein by reference.

It may be desirable to use finishing steps and/or post treatment processes to impart selected properties to the composite 36. For example, the nonwoven composite may be lightly pressed by calendar rolls, creped or brushed to provide a uniform exterior appearance and/or certain tactile properties. Alternatively and/or additionally, chemical post-treatments such as, adhesives or dyes may be added to the nonwoven composite.

In one aspect of the invention, the nonwoven composite may contain various materials such as, for example, activated charcoal, clays, starches, and superabsorbent materials. For example, these materials may be added to the suspension of fibers used to form the fiber layer. These materials may also be deposited on the fibers prior to the fluid jet treatments so that they become incorporated into the nonwoven composite by the action of the fluid jets. Alternatively and/or additionally, these materials may be added to the nonwoven composite after the fluid jet treatments. If superabsorbent materials are added to the suspension of fibers or to the fiber layer before water-jet treatments, it is preferred that the superabsorbents are those which can remain inactive during the wet-forming and/or water-jet treatment steps and can be activated later. Conventional superabsorbents may be added to the nonwoven composite after the water-jet treatments. Useful superabsorbents include, for example, a sodium polyacrylate superabsorbent available from the Hoechst Celanese Corporation under the trade name Sanwet IM-5000P. Superabsorbents may be present at a proportion of up to about 50 grams of superabsorbent per 100 grams of fibers in the fiber layer. For example, the nonwoven web may contain from about 15 to about 30 grams of superabsorbent per 100 grams of fibers. More particularly, the nonwoven web may contain about 25 grams of superabsorbent per 100 grams of fibers.

As is stated above, the present invention is based on the discovery that a nonwoven composite containing 40% or more by weight of fibrous materials from post consumer recycled fibers, when hydroentangled has physical properties which are equal to or nearly equal to a nonwoven composite prepared from virgin materials. These results are shown in the following examples and comparative examples.

### EXAMPLES

### Test Procedures

Caliper: The caliper of a fabric corresponds to its thickness. The caliper was measured in the example in accordance with TAPPI test methods T402 “Standard Conditioning and Testing Atmosphere For Paper, Board, Pulp Handsheets and Related Products” or T411 om-89 “Thickness (caliper) of Paper, Paperboard, and Combined Board” with Note 3 for stacked sheets. The micrometer used for carrying out T411 om-89 may be an Emveco Model 200A Electronic Microgage (made by Emveco, Inc. of Newberry, Oreg.) having an anvil diameter of 57.2 millimeters and an anvil pressure of 2 kilopascals.

Grab Tensile Strength: The grab tensile test is a measure of breaking strength of a fabric when subjected to unidirectional stress. This test is known in the art and conforms to the specifications of Method 5100 of the Federal Test Methods Standard 191A. The results are expressed in pounds to break. Higher numbers indicate a stronger fabric. The grab tensile test uses two clamps, each having two jaws with each jaw having a facing in contact with the sample. The clamps hold the material in the same plane, usually vertically, separated by 3 inches (76 mm) and move apart at a specified rate of extension. Values for grab tensile strength are obtained using a sample size of 4 inches (102 mm) by 6 inches (152 mm), with a jaw facing size of 1 inch (25 mm) by 1 inch, and a constant rate of extension of 300 mm/min. The sample is wider than the clamp jaws to give results representative of effective strength of fibers in the clamped width combined with additional strength contributed by adjacent fibers in the fabric. The specimen is clamped in, for example, a Sintech 2 tester, available from the Sintech Corporation of Cary, N.C., an Instron Model™, available from the Instron Corporation of Canton, Mass., or a Thwing-Albert Model INTELLECT II available from the Thwing-Albert Instrument Co. of Philadelphia, Pa. This closely simulates fabric stress conditions in actual use. Results are reported as an average of three specimens and may be performed with the specimen in the cross direction (CD) or the machine direction (MD).

Water Intake Rate: The intake rate of water is the time required, in seconds, for a sample to completely absorb the liquid into the web versus sitting on the material surface. Specifically, the intake of water is determined according to ASTM No. 2410 by delivering 0.5 cubic centimeters of water with a pipette to the material surface. Four (4) 0.5-cubic centimeter drops of water (2 drops per side) are applied to each material surface. The average time for the four drops of water to wick into the material (z-direction) is recorded. Lower absorption times, as measured in seconds, are indicative of a faster intake rate. The test is run at conditions of 73.4°±3.6° F. and 50%±5% relative humidity.

Intake Rate: The intake rate of oil is the time required, in seconds, for a sample to absorb a specified amount of oil. The intake of 50 W motor oil is determined in the same manner described above for water, except that 0.1 cubic centimeters of oil is used for each of the four (4) drops (2 drops per side).

Absorption Capacity: The absorption capacity refers to the capacity of a material to absorb a liquid (e.g., water or motor oil) over a period of time and is related to the total amount of liquid held by the material at its point of saturation. The absorption capacity is measured in accordance with Federal Specification No. UU-T-595C on industrial and institutional towels and wiping papers. Specifically, absorption capacity is determined by measuring the increase in the weight of the sample resulting from the absorption of a liquid and is expressed as either the weight of liquid absorbed or the % liquid absorbed, using the following equations:

Absorption Capacity=(saturated sample weight-sample weight).

or

Absorption Capacity=[(saturated sample weight-sample weight)/sample weight]×100.

Taber Abrasion Resistance: Taber Abrasion resistance measures the abrasion resistance in terms of destruction of the fabric produced by a controlled, rotary rubbing action. Abrasion resistance is measured in accordance with Method 5306, Federal Test Methods Standard No. 191A, except as otherwise noted herein. Only a single wheel is used to abrade the specimen. A 12.7×12.7-cm specimen is clamped to the specimen platform of a Taber Standard Abrader (Model No. 504 with Model No. E-140-15 specimen holder) having a rubber wheel (No. H-18) on the abrading head and a 500-gram counterweight on each arm. The loss in breaking strength is not used as the criteria for determining abrasion resistance. The results are obtained and reported in abrasion cycles to failure where failure was deemed to occur at that point where a 0.5-cm hole is produced within the fabric.

Cup Crush: The softness of a nonwoven fabric may be measured according to the “cup crush” test. The cup test evaluates fabric stiffness by measuring the peak load required for a 4.5 cm diameter hemispherically shaped foot to crush a 23 cm by 23 cm piece of fabric shaped into an approximately 6.5 cm diameter by 6.5 cm tall inverted cup while the cup shaped fabric is surrounded by an approximately 6.5 cm diameter cylinder to maintain a uniform deformation of the cup shaped fabric. An average of 10 readings is used. The foot and the cup are aligned to avoid contact between the cup walls and the foot which could affect the readings. The peak load is measured while the foot is descending at a rate of about 0.25 inches per second (38 cm per minute) and is measured in grams. A lower cup crush value indicates a softer laminate. The cup crush test also yields a value for the total energy required to crush a sample (the “cup crush energy”) which is the energy from the start of the test to the peak load point, i.e. the area under the curve formed by the load in grams on one axis and the distance the foot travels in millimeters on the other. Cup crush energy is reported in gf*mm. A suitable device for measuring cup crush is a model FTD-G500 load cell (500 gm range) available from the Schaevitz Company, Pennsauken, N.J.

The following examples and comparative examples were prepared to demonstrate the unexpected properties of the nonwoven composite of the present invention. The following are five examples or embodiments made in accordance with the present invention.

### Example I

A composite having about 43% post-consumer recycled material in total content was prepared. The composite had a target basis weight of 82 gsm (grams per square meter) and was composed of a target amount of 35 gsm virgin pulp (50% NSWK/50% SSWK) and 35 gsm post-consumer Old Corrugated Container recycled material and 12 gsm virgin polypropylene spunbond material. The hydroentangling step consisted of a single pass under two hydroentangling injectors at 1200 psig each and a second pass of two hydroentangling jets at 1500 psig each. The injectors used a jet strip with capillary diameters of 120 microns and 40 holes per inch. The line speed for the first hydroentangling pass was 35 fpm and for the second pass at 100 fpm. The tested basis weight and tested properties are shown in Table 1.

### Comparative Example 1

A composite having about 0% post-consumer recycled material in total content was prepared. The composite had a target basis weight of 82 gsm (grams per square meter) and was composed of a target amount of 70 gsm virgin pulp (50% NSWK/50% SSWK) and 12 gsm virgin polypropylene spunbond material. The hydroentangling step consisted of a single pass under two hydroentangling injectors at 1200 psig each and a second pass of two hydroentangling jets at 1500 psig each. The injectors used a jet strip with capillary diameters of 120 microns and 40 holes per inch. The line speed for the first hydroentangling pass was 35 fpm and for the second pass at 100 fpm. The tested basis weight and tested properties are shown in Table 1.

### Example II

A control composite having about 60% post-consumer recycled material in total content was prepared. The composite had a target basis weight of 120 gsm and was composed of a target amounts 47.5 gsm virgin pulp (50% NSWK/50% SSWK) and 47.5 gsm post-consumer Old Corrugated Container recycled material and 25 gsm post-consumer recycled material of polyester spunbond. The hydroentangling step consisted of a single pass under two hydroentangling injectors at 1200 psig each and a second pass of two hydroentangling jets at 1500 psig each. The injectors used a jet strip with capillary diameters of 120 microns and 40 holes per inch. The line speed for the first hydroentangling pass was 23 fpm and for the second pass at 100 fpm. The tested basis weight and tested properties are shown in Table 1.

### Example III

A composite having 100% post-consumer recycled material in total content was prepared. The composite had a target basis weight of 120 gsm and was composed of a target amount of 95 gsm post-consumer Old Corrugated Container recycled material and 25 gsm post-consumer recycled material of polyester spunbond. The hydroentangling step consisted of a single pass under two hydroentangling injectors at 1100 psig each and a second pass of two hydroentangling jets at 1500 psig each. The injectors used a jet strip with capillary diameters of 120 microns and 40 holes per inch. The line speed for the first hydroentangling pass was 17 fpm and for the second pass at 100 fpm. The tested basis weight and tested properties are shown in Table 1.

### Example IV

A composite having about 51% post-consumer recycled material in total content was prepared. The composite had a target basis weight of 120 gsm and was composed of target amounts of 6 gsm post-consumer Old Corrugated Container recycled material, 59 gsm virgin pulp (50% NSWK/50% SSWK), 30 gsm of 12 mm virgin polyester staple fibers formed onto its surface, and 25 gsm post-consumer recycled material of polyester spunbond. The hydroentangling step consisted of a single pass under two hydroentangling injectors at 1100 psig each and a second pass of two hydroentangling jets at 1500 psig each. The injectors used a jet strip with capillary diameters of 120 microns and 40 holes per inch. The line speed for the first hydroentangling pass was 17 fpm and for the second pass at 100 fpm. The tested basis weight and tested properties are shown in Table 1.

### Comparative Example 2

A control composite having about 0% post-consumer recycled material in total content was prepared. The composite had a target basis weight of 120 gsm (grams per square meter) and was composed of a target amount of 95 gsm virgin pulp (50% NSWK/50% SSWK) and 25 gsm virgin polypropylene spunbond material. The hydroentangling step consisted of a single pass under two hydroentangling injectors at 1200 psig each and a second pass of two hydroentangling jets at 1500 psig each. The injectors used a jet strip with capillary diameters of 120 microns and 40 holes per inch. The line speed for the first hydroentangling pass was 35 fpm and for the second pass at 100 fpm. The tested basis weight and tested properties are shown in Table 1.

TABLE 1

| | | | | CDW | | MDW | | | | Total | | |
|---|---|---|---|---|---|---|---|---|---|---|---|---|
| | | Wet | | Grab | | Grab | MDW Grab | Total | | Abs. | | |
| | Basis | Abrasion | Cup Crush | Tensile, | CDW Grab | Tensile, | Tensile, | Abs. Cap | Oil | Cap. | Water | Abs. |
| | Weight | Taber- | Peak load | Peak Load | Tensile, | Peak Load | Peak | Oil | Specific | Water | Specific | Rate |
| Example | g/m² | Cycles | g_{f} | lbf | Peak Stretch % | lb_{f} | Stretch % | grams | Cap g/g | grams | Cap g/g | sec |
| Comparative | 91 | 18 | 484 | 16 | 128 | 19 | 39 | 3.9 | 4.1 | 3.0 | 4.4 | 2.6 |
| Example 1 | | | | | | | | | | | | |
| Example 1 | 86 | 30 | 867 | 14.4 | 76 | 17 | 36 | 4.7 | 5.4 | 3.7 | 4.1 | 2.3 |
| Comparative | 131 | 88 | 705 | 17.5 | 84 | 27 | 33 | 5.4 | 4.1 | 4.6 | 3.4 | 3.2 |
| Example 2 | | | | | | | | | | | | |
| Example IV | 134 | 142 | 1626 | 30 | 70 | 47 | 44 | 6.7 | 4.8 | 5.5 | 4.0 | 0.8 |
| Example II | 135 | 107 | 1372 | 18.8 | 91 | 26 | 26 | 5.7 | 4.0 | 4.9 | 3.5 | 1.4 |
| Example III | 146 | 62 | 1392 | 15.0 | 91 | 22 | 20 | 6.5 | 4.3 | 5.6 | 3.7 | 13 |

TABLE 2

| | | | | | | Cup | | |
|---|---|---|---|---|---|---|---|---|
| | | | Water | Mineral | OIL | Crush | | |
| | | Water | Specific | Oil | Specific | Peak | | |
| Code | Taber | Capacity g | Cap g/g | Capacity g | Cap g/g | load gf | CDW | MDW |
| | % Change from Comparative Example 1 | | | | | | | |
| Example 1 | 67% | 23% | −7% | 21% | 32% | 79% | −10% | −11% |
| | % Change from Comparative Example 2 | | | | | | | |
| Example 4 | 61% | 20% | 18% | 24% | 17% | 130% | 71% | 74% |
| Example 2 | 22% | 7% | 3% | 6% | −2% | 95% | 7% | −4% |
| Example 3 | −30% | 22% | 9% | 20% | 5% | 97% | −14% | −19% |

Table 2 shows the differences in the properties of the composite of the present invention with its post-consumer recycled content as compared to a composite prepared from virgin materials. As can be seen in Table 2, the composites containing post consumer recycled materials has properties that are better than or on par with the a composite from virgin materials. This result is unexpected since other wiping type products containing recycled fibers typically have a reduction physical properties as the recycled content is increased.

To demonstrate the unexpected properties obtained by the hydroentangled nonwoven composite of the present invention, the present inventors prepared various samples of a double recreped tissue product in accordance with U.S. Pat. No. 3,879,257 including varying amounts of post-consumer recycled fibers. These samples contained 0% by weight post-consumer recycled fibers, which is the control, 20% by weight post-consumer recycled fibers (Sample A), 30% by weight post-consumer recycled fibers (Sample B) and 40% by weight post-consumer recycled fibers (Sample C). The tissue samples were prepared form a paper furnish containing 62% Hardwood (short fibers) and 38% Softwood (long fibers), with the only difference being between each sample is the amount of post consumer recycled fibers incorporated into the furnish. Various properties were tested including caliper, water specific capacity, water intake rate, and motor oil total capacity. Also the wet and dry strength were tested. The test results are shown in Table 3 below.

TABLE 3

| Attributes-Sampling n = 8 | Control | Sample A | Sample B | Sample C | A vs. CTL | B Vs. CTL | C Vs. CTL |
|---|---|---|---|---|---|---|---|
| Bulk | CTL | A | B | C | % change | % change | % change |
| Basis Weight (gsm) | 83.4 | 84.2 | 84 | 84.9 | 1.0% | 0.8% | 1.8% |
| Caliper - 24 sheets (in/24) | 0.625 | 0.508 | 0.509 | 0.44 | −18.7% | −18.6% | −29.6% |
| Absorbency | | | | | | | |
| Water Total Cap. (g) | 5.88 | 5.05 | 4.79 | 4.23 | −14.1% | −18.5% | −28.1% |
| Water Specific Cap. (g/g) | 6.86 | 5.82 | 4.89 | 4.23 | −15.2% | −28.7% | −38.3% |
| Water Rate (0.1 cc/ml) (sec) | 0.5 | 0.55 | 0.6 | 1.1 | 10.0% | 20.0% | 120.0% |
| Motor Oil Total Capacity (g) | 7.57 | 6.76 | 6.59 | 5.63 | −10.7% | −12.9% | −25.6% |
| Strength | | | | | | | |
| MD Dry - Peak Load | 3749 | 3430 | 3327 | 3624 | −8.5% | −11.3% | −3.3% |
| CD Dry - Peak Load | 3244.6 | 2703 | 2657 | 2872 | −16.7% | −18.1% | −11.5% |
| MD Wet - Peak Load | 2462 | 2303.2 | 2230 | 2071 | −6.5% | −9.4% | −15.9% |
| CD Wet - Peak Load | 2076 | 1910 | 1610 | 1527 | −8.0% | −22.4% | −26.4% |

As can be seen in the Table 3, generally as recycled fibers are incorporated into a wiper product, the physical properties of the wiper tends to decrease as compared to the control. As a result, those skilled in the art would have expected that the properties of the composite of the present invention to also decrease as the post consumer recycled content increases. However, as is clearly shown above, this is not the case and the composite of the present invention, with at least 40% by weight of recycled content has physical properties which are on par with or are better than the properties of the control composite without recycled materials. This result is unexpected given that recycled fiber generally reduce.

Although the present invention has been described with reference to various embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1. A nonwoven composite web comprising:
a continuous fiber nonwoven web, and
a layer of discontinuous fibers hydroentangled with the nonwoven continuous fiber web to form a nonwoven composite,
wherein the nonwoven composite comprises at least 40% by weight of the composite of a post-consumer recycled material.

2. The nonwoven composite according to claim 1, wherein the continuous fiber nonwoven web of the nonwoven composite comprises the post-consumer recycled material.

3. The nonwoven composite according to claim 1, wherein the discontinuous fibers of the nonwoven composite comprise the post-consumer recycled material.

4. The nonwoven composite according to claim 1, wherein both the continuous fiber nonwoven web and the discontinuous fibers comprise the post-consumer recycled material.

5. The nonwoven composite according to claim 1, wherein the nonwoven composite comprises between about 40% to about 80% by weight of the composite of the post-consumer recycled material.

6. The nonwoven composite according to claim 5, wherein the nonwoven composite comprises between about 45% to about 65% by weight of the composite of the post-consumer recycled material.

7. The nonwoven composite according to claim 1, wherein the nonwoven composite comprises 100% by weight of the composite of the post-consumer recycled material.

8. The nonwoven composite according to claim 1, wherein the composite has a basis weight between about 20 grams per square meter to about 200 grams per square meter.

9. The nonwoven composite according to claim 1, wherein the continuous fiber web is bonded.

10. The nonwoven composite according to claim 9, wherein the continuous fiber web has a bond density greater than about 250 point bonds per square inch and the total bond area is less than about 30 percent.

11. The nonwoven composite according to claim 1, wherein the post consumer recycled material comprises pulp fibers.

12. The nonwoven composite according to claim 1, wherein the post consumer recycled material comprises polyethylene terephthalate and/or polypropylene.

13. The nonwoven composite according to claim 12, wherein the continuous fiber nonwoven web of the nonwoven composite comprises the post-consumer recycled material.

14. The nonwoven composite according to claim 12, wherein the discontinuous fibers of the nonwoven composite comprise the post-consumer recycled material.

15. The nonwoven composite according to claim 1, wherein the discontinuous fibers comprises a mixture of post-consumer recycled pulp fibers and post consumer recycled polyethylene terephthalate and/or polypropylene.

16. The nonwoven composite according to claim 1, wherein the continuous fiber nonwoven web comprises a spunbond nonwoven web, and the discontinuous fibers comprise pulp fibers.

17. The nonwoven composite according to claim 16, wherein the discontinuous fibers further comprise synthetic staple fibers.

18. The nonwoven web composite according to claim 16, wherein the spunbond nonwoven web comprises a post consumer recycled polyethylene terephthalate and/or polypropylene.

19. A wiper comprising the nonwoven composite according to claim 1.

20. A wiper comprising the nonwoven composite according to claim 18.
